(19) United States
(12) Patent Application Publication
(10) Pub. No.: US 2015/0332728 A1
(43) Pub. Date: Nov. 19, 2015

(54) Hard Disk Drive Base Having Vibration Propagation Mitigation Feature

(71) Applicant: HGST NETHERLANDS B.V., Amsterdam (NL)

(72) Inventors: Teruhiro Nakamiya, Kawasaki-shi (JP); Hiromitsu Masuda, Odawara-shi (JP); Kenji Tomida, Ashigarakamigun (JP); Hajime Mori, Atsugi-shi (JP)

(73) Assignee: HGST NETHERLANDS B.V., Amsterdam (NL)

(21) Appl. No.: 14/280,452

(22) Filed: May 16, 2014

(51) Int. Cl. G11B 19/20

(52) U.S. Cl. CPC G11B 19/2018

(57) ABSTRACT

A hard disk drive (HDD) enclosure base is described, in which a mechanical feature is implemented that mitigates the propagation of vibration through the base. For example, an HDD base as described can mitigate the propagation of vibration to the head suspension and thereby eliminate read-back signal losses resulting from such vibration, such as in response to an op-shock event.

### FIELD OF EMBODIMENTS

Embodiments of the invention may relate generally to hard disk drives and more particularly to a hard disk drive enclosure base.

### BACKGROUND

A hard-disk drive (HDD) is a non-volatile storage device that is housed in a protective enclosure and stores digitally encoded data on one or more circular disks having magnetic surfaces. When an HDD is in operation, each magnetic-recording disk is rapidly rotated by a spindle system. Data is read from and written to a magnetic-recording disk using a read/write head that is positioned over a specific location of a disk by an actuator. A read/write head uses a magnetic field to read data from and write data to the surface of a magnetic-recording disk. Write heads make use of the electricity flowing through a coil, which produces a magnetic field. Electrical pulses are sent to the write head, with different patterns of positive and negative currents. The current in the coil of the write head induces a magnetic field across the gap between the head and the magnetic disk, which in turn magnetizes a small area on the recording medium.

Increasing areal density (a measure of the quantity of information bits that can be stored on a given area of disk surface) is one of the ever-present goals of hard disk drive design evolution. In turn, as recording tracks in HDDs become narrower and narrower and bits are recorded smaller and smaller, there is a need for more accurate and sustainable head positioning. Furthermore, customers mandate meeting stringent performance requirements, including operational shock (or “op-shock”) requirements, which generally relate to an HDD's operational resistance to or operational tolerance of a shock event.

One scenario that may occur in response to a shock event is for a fluid dynamic bearing (FDB) associated with a disk spindle motor to hit its stopper. Such FDB hitting tends to excite the HDD base to which the spindle motor is attached, near the spindle motor, causing the base to vibrate. This base vibration can have a negative effect on other components within the HDD, especially those components directly coupled to the base. Thus, the manner in which vibration is managed is an important factor in improving the performance and reliability of HDDs.

Any approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### SUMMARY OF EMBODIMENTS

Embodiments of the invention are directed toward a hard disk drive (HDD) and corresponding enclosure base that includes a mechanical feature that mitigates the propagation of vibration through the base. Thus, according to an embodiment, an HDD base as described can mitigate the propagation of vibration to the head suspension and therefore eliminate read-back signal losses resulting from such vibration, such as in response to an op-shock event.

According to an embodiment, the base comprises an opening or hole that mitigates the propagation of vibration through the base. According to an embodiment, the opening in the base is positioned between where the spindle motor is attached to the base and where the voice coil motor is attached to the base, thereby mitigating the propagation of vibration of the base from near the spindle motor to near the voice coil motor and in turn to the head suspension, thereby eliminating read-back signal loss due to the head slider jumping from its intended position over the disk.

Embodiments discussed in the Summary of Embodiments section are not meant to suggest, describe, or teach all the embodiments discussed herein. Thus, embodiments of the invention may contain additional or different features than those discussed in this section.

### BRIEF DESCRIPTION OF THE DRAWINGS

Embodiments of the invention are illustrated by way of example, and not by way of limitation, in the figures of the accompanying drawings and in which like reference numerals refer to similar elements and in which:

FIG. 1 is a plan view illustrating a hard disk drive (HDD), according to an embodiment of the invention; and

FIG. 2 is a bottom view illustrating an HDD base, according to an embodiment of the invention.

### DETAILED DESCRIPTION

Approaches to a hard disk drive base structure that comprises a mechanical feature that mitigates the propagation of vibration through the base are described. In the following description, for the purposes of explanation, numerous specific details are set forth in order to provide a thorough understanding of the embodiments of the invention described herein. It will be apparent, however, that the embodiments of the invention described herein may be practiced without these specific details. In other instances, well-known structures and devices are shown in block diagram form in order to avoid unnecessarily obscuring the embodiments of the invention described herein.

### PHYSICAL DESCRIPTION OF ILLUSTRATIVE EMBODIMENTS

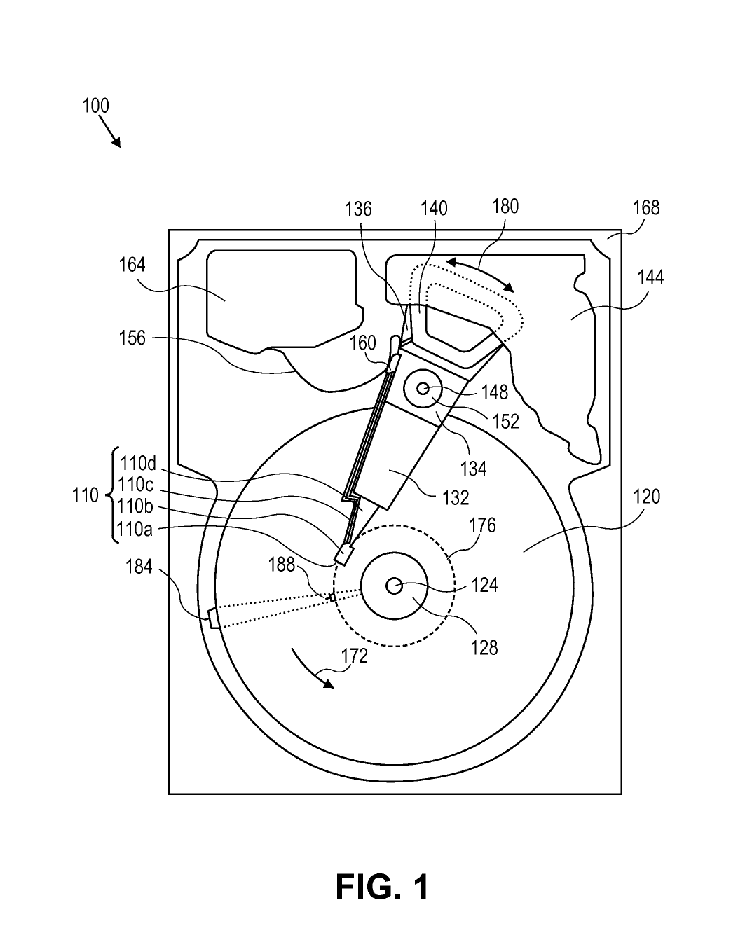

Embodiments of the invention may be used in the context of a hard-disk drive (HDD) enclosure base. Thus, in accordance with an embodiment of the invention, a plan view illustrating an HDD 100 is shown in FIG. 1. FIG. 1 illustrates the functional arrangement of components of the HDD including a slider 110b that includes a magnetic-reading/recording head 110a. Collectively, slider 110b and head 110a may be referred to as a head slider. The HDD 100 includes at least one head gimbal assembly (HGA) 110 including the head slider, a lead suspension 110c attached to the head slider typically via a flexure, and a load beam 110d attached to the lead suspension 110c. The HDD 100 also includes at least one magnetic-recording media 120 rotatably mounted on a spindle 124 and a drive motor (not visible) attached to the spindle 124 for rotating the media 120. The head 110a includes a write element and a read element for respectively writing and reading information stored on the media 120 of the HDD 100. The media 120 or a plurality of disks may be affixed to the spindle 124 with a disk clamp 128.

The HDD 100 further includes an arm 132 attached to the HGA 110, a carriage 134, a voice-coil motor (VCM) that includes an armature 136 including a voice coil 140 attached to the carriage 134; and a stator 144 including a voice-coil magnet (not visible). The armature 136 of the VCM is attached to the carriage 134 and is configured to move the arm 132 and the HGA 110, to access portions of the media 120, being mounted on a pivot-shaft 148 with an interposed pivot-bearing assembly 152. In the case of an HDD having multiple disks, or platters as disks are sometimes referred to in the art, the carriage 134 is called an “E-block,” or comb, because the carriage is arranged to carry a ganged array of arms that gives it the appearance of a comb.

An assembly comprising a head gimbal assembly (e.g., HGA 110) including a flexure to which the head slider is coupled, an actuator arm (e.g., arm 132) to which the flexure is coupled, and an actuator (e.g., the VCM) to which the actuator arm is coupled, may be collectively referred to as a head stack assembly (HSA). An HSA may, however, include more or fewer components than those described. For example, an HSA may refer to an assembly that further includes electrical interconnection components. Generally, an HSA is the assembly configured to move the head slider to access portions of the media 120 (e.g., magnetic-recording disks) for read and write operations.

With further reference to FIG. 1, in accordance with an embodiment of the present invention, electrical signals, for example, current to the voice coil 140 of the VCM, write signal to and read signal from the head 110a, are provided by a flexible interconnect cable 156 (“flex cable”). Interconnection between the flex cable 156 and the head 110a may be provided by an arm-electronics (AE) module 160, which may have an on-board pre-amplifier for the read signal, as well as other read-channel and write-channel electronic components. The AE 160 may be attached to the carriage 134 as shown. The flex cable 156 is coupled to an electrical-connector block 164, which provides electrical communication through electrical feedthroughs provided by an HDD housing 168. The HDD housing 168, also referred to as a casting, depending upon whether the HDD housing is cast, in conjunction with an HDD cover provides a sealed, protective enclosure for the information storage components of the HDD 100.

Continuing with reference to FIG. 1, in accordance with an embodiment of the present invention, other electronic components, including a disk controller and servo electronics including a digital-signal processor (DSP), provide electrical signals to the drive motor, the voice coil 140 of the VCM and the head 110a of the HGA 110. The electrical signal provided to the drive motor enables the drive motor to spin providing a torque to the spindle 124 which is in turn transmitted to the media 120 that is affixed to the spindle 124 by the disk clamp 128; as a result, the media 120 spins in a direction 172. The spinning media 120 creates a cushion of air that acts as an air-bearing on which the air-bearing surface (ABS) of the slider 110b rides so that the slider 110b flies above the surface of the media 120 without making contact with a thin magnetic-recording medium in which information is recorded.

The electrical signal provided to the voice coil 140 of the VCM enables the head 110a of the HGA 110 to access a track 176 on which information is recorded. Thus, the armature 136 of the VCM swings through an arc 180 which enables the HGA 110 attached to the armature 136 by the arm 132 to access various tracks on the media 120. Information is stored on the media 120 in a plurality of stacked tracks arranged in sectors on the media 120, for example, sector 184. Correspondingly, each track is composed of a plurality of sectored track portions (or “track sector”), for example, sectored track portion 188. Each sectored track portion 188 is composed of recorded data and a header containing a servo-burst-signal pattern, for example, an ABCD-servo-burst-signal pattern, information that identifies the track 176, and error correction code information. In accessing the track 176, the read element of the head 110a of the HGA 110 reads the servo-burst-signal pattern which provides a position-error-signal (PES) to the servo electronics, which controls the electrical signal provided to the voice coil 140 of the VCM, enabling the head 110a to follow the track 176. Upon finding the track 176 and identifying a particular sectored track portion 188, the head 110a either reads data from the track 176 or writes data to the track 176 depending on instructions received by the disk controller from an external agent, for example, a microprocessor of a computer system.

References herein to a hard disk drive, such as HDD 100 illustrated and described in reference to FIG. 1, may encompass a data storage device that is at times referred to as a “hybrid drive”. A hybrid drive refers generally to a storage device having functionality of both a traditional HDD (see, e.g., HDD 100) combined with solid-state storage device (SSD) using non-volatile memory, such as flash or other solid-state (e.g., integrated circuits) memory, which is electrically erasable and programmable. As operation, management and control of the different types of storage media typically differs, the solid-state portion of a hybrid drive may include its own corresponding controller functionality, which may be integrated into a single controller along with the HDD functionality. A hybrid drive may be architected and configured to operate and to utilize the solid-state portion in a number of ways, such as, for non-limiting examples, by using the solid-state memory as cache memory, for storing frequently-accessed data, for storing I/O intensive data, and the like. Further, a hybrid drive may be architected and configured essentially as two storage devices in a single enclosure, i.e., a traditional HDD and an SSD, with either one or multiple interfaces for host connection.

### INTRODUCTION

As mentioned, one scenario that may occur in response to a shock event is for a fluid dynamic bearing (FDB) associated with a disk spindle motor to hit its stopper, which tends to excite the HDD base near the spindle motor, causing the base to vibrate. This base vibration propagates through the base to an area under the voice coil actuator pivot shaft, which in turn propagates to the head-stack assembly (HSA) and its constituent components including the suspension and head slider. If the HSA vibration is significant enough then the slider may abruptly jump from its position over the disk. Not only does this abrupt movement affect the ability of the read sensor to read-back a robust signal, and quite likely cause at least a momentary read-back signal loss, but such slider movement may also cause a head-disk crash which is likely to result in head and/or disk damage. Therefore, reducing the vibration of the HSA, generally, and in response to an op-shock event, specifically, is desirable.

### ENCLOSURE BASE WITH A VIBRATION PROPAGATION MITIGATION FEATURE

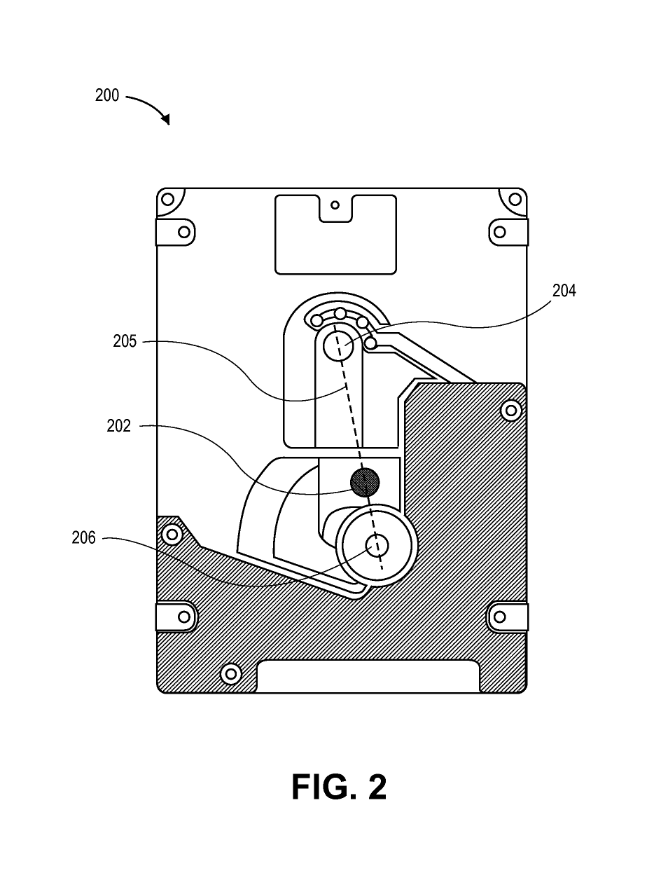

FIG. 2 is a bottom view illustrating an HDD base, according to an embodiment of the invention. As depicted in FIG. 2, HDD base 200 is configured with a mechanical vibration propagation mitigation feature 202 (hereafter, simply “feature 202”) that mitigates the propagation of vibration through the base 200.

According to embodiments, feature 202 comprises a hole, or opening, which may be substantially circular in form or non-circular in form. Further, according to embodiments, the feature 202 comprising a hole or opening may pass completely through the thickness of the bottom of the base or may travel only partially through the bottom of the base.

By interrupting the continuity of the base 200 material the vibrational energy transmitting through the base is redirected and attenuated in the direction in which the feature 202 lies. Continuing with reference to FIG. 2, base 200 further comprises an area 204 in which a spindle (see, e.g., spindle 124 of FIG. 1) and corresponding spindle (drive) motor assembly, which drives the rotation of the disk(s), is attached to the base 200. Recall that it is the vibrational excitation of the base 200 near the spindle motor assembly in response to a shock event that is of some particular interest in regards to a source of the vibrational energy, propagating through the base, which may be mitigated. However, other sources and other vibrational energies may similarly be mitigated using embodiments described and claimed herein. Further, base 200 comprises an area 206 in which a voice coil motor (VCM) shaft (see, e.g., pivot-shaft 148 of FIG. 1) is attached to the base 200. Recall that it is the vibrational energy arriving at the pivot shaft, which in turn propagates to the head-stack assembly (HSA) and its constituent components including the suspension and head slider, that is of some particular interest in regards to a detrimental effect of the vibrational energy propagating through the base.

Therefore, and according to an embodiment, feature 202 is positioned between the spindle motor, corresponding area 204, and the VCM pivot shaft, corresponding area 206, to mitigate the propagation of vibration from area 204 to area 206, and thereby onto the suspension and head slider. In a related embodiment, feature 202 is positioned on a linear path (depicted as dashed line 205) between the spindle motor, corresponding area 204, and the VCM pivot shaft, corresponding area 206.

By implementing a vibration propagation mitigation feature 202 on the base 200, analysis shows that the higher order vibration of base 202 under pivot shaft area 206 is reduced and the vibration of the suspension is likewise reduced. Thus, the read-back signal does not dematerialize, which means the slider does not jump from the disk and a desirable effect is achieved.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

1. A hard disk drive comprising:
a magnetic-recording disk rotatably mounted on a spindle rotably driven by a spindle motor assembly;
a voice coil motor configured to move a head slider to access portions of said disk; and
an enclosure base with which said spindle motor assembly is coupled, said enclosure base comprising an empty hole that is positioned to mitigate the propagation of vibration from said base near said spindle motor to said base near said voice coil motor.

2. (canceled)

3. The hard disk drive of claim 1, wherein said empty hole is a cylindrical.

4. The hard disk drive of claim 1, wherein said empty hole is non cylindrical.

5. The hard disk drive of claim 1, wherein said empty hole passes completely through said enclosure base.

6. The hard disk drive of claim 1, wherein said empty hole is formed only partially through said enclosure base.

7. The hard disk drive of claim 1,
wherein said empty hole is positioned entirely between said spindle motor and said voice coil motor.

8. The hard disk drive of claim 7, wherein said empty hole is positioned on a linear path between said spindle motor and said voice coil motor.

9. (canceled)

10. The hard disk drive of claim 1, comprising:
a suspension coupled with an actuator arm;
said voice coil motor configured to move said suspension and a head slider to access portions of said disk; and
wherein said empty hole is positioned entirely between said spindle motor and said voice coil motor to mitigate the propagation of vibration from said base near said spindle motor to said suspension.

11. A hard disk drive enclosure base comprising:
an empty opening positioned to mitigate the propagation of vibration through said base and between components coupled with said base.

12. The hard disk drive enclosure base of claim 11, wherein said empty opening is positioned entirely between where a spindle motor is attached to said base and where an actuator pivot-shaft is attached to said base and is configured to mitigate the propagation of vibration from said base near said spindle motor to said base near said actuator pivot-shaft.

13. The hard disk drive enclosure base of claim 11, wherein said empty opening is cylindrical.

14. The hard disk drive enclosure base of claim 11, wherein said empty opening is non-cylindrical.

15. The hard disk drive enclosure base of claim 11, wherein said empty opening passes completely through said enclosure base.

16. The hard disk drive of enclosure base of claim 11, wherein said empty opening is formed only partially through said enclosure base.

17. A hard disk drive comprising:
means for mitigating the propagation of vibration through a hard disk drive enclosure base.

18. The hard disk drive of claim 17, wherein said means for mitigating is positioned entirely between where a spindle motor is attached to said enclosure base and where an actuator is attached to said enclosure base.

19. The hard disk drive of claim 17, wherein said means for mitigating is positioned on a linear path between where said spindle motor is attached to said enclosure base and where said actuator is attached to said enclosure base.

20. The hard disk drive of claim 17, wherein said means for mitigating is configured to mitigate the propagation of vibration through said enclosure base from near where said spindle motor is attached to near where said actuator is attached.
